(19) United States
(12) Patent Application Publication
(10) Pub. No.: US 2020/0262040 A1
(43) Pub. Date: Aug. 20, 2020

(54) UNLOCKING TOOL FOR A BOLT LOCKING SYSTEM

(71) Applicant: Airbus Operations SAS, Toulouse (FR)

(72) Inventor: Paolo MESSINA, TOULOUSE (FR)

(21) Appl. No.: 16/778,202

(22) Filed: Jan. 31, 2020

(30) Foreign Application Priority Data
Feb. 15, 2019 (FR) 1901544

(51) Int. Cl. B25B 29/00; F16B 39/32

(52) U.S. Cl. CPC B25B 29/00; F16B 39/32

(57) ABSTRACT

An unlocking tool configured for unlocking a locking system that prevents a nut from rotating with respect to a threaded stem, comprising a ring configured to be positioned around the threaded stem in operation and at least one finger extending between a first end connected to the ring and a second, free end, this finger being configured to be received and slide in a longitudinal channel of the threaded stem in operation, each finger comprising a front face that is configured to cooperate with at least one tab of the locking system so as to prevent it becoming immobilized in one of the longitudinal channels of the threaded stem.

### CROSS-REFERENCES TO RELATED APPLICATIONS

This application claims the benefit of the French patent application No. 1901544 filed on Feb. 15, 2020, the entire disclosures of which are incorporated herein by way of reference.

### FIELD OF THE INVENTION

The present application relates to an unlocking tool for a bolt locking system.

### BACKGROUND OF THE INVENTION

U.S. Pat. No. 6,010,289 describes various locking systems that serve to prevent a nut from rotating with respect to a threaded stem of a bolt.

According to a first embodiment, shown in FIG. 1, a locking system 10, as one with the nut, takes the form of a ring. This locking system 10 comprises a tubular body 12 whose internal diameter is slightly greater than the diameter of the threaded stem, so as to be able to fit around the latter. This tubular body 12 comprises multiple C-shaped cuts 14, distributed over the periphery of the tubular body 12, each forming a tab 16 that is configured to occupy a non-deformed state, in which the tab 16 projects inside the tubular body 12 and is partially received in a notch provided in the threaded stem, and a deformed state, in which the tab 16 is no longer received in the notch provided in the threaded stem. Each tab 16 is connected to the rest of the tubular body 12 by a bending line 18 oriented parallel to the axis of the nut, and has a free edge 20 that is essentially parallel to the bending line 18. The latter and the free edge 20 are configured such that, when the tab 16 is in the non-deformed state in the notch of the threaded stem, it prevents the nut from rotating in the loosening direction. According to this first embodiment, the tab deforms during tightening. When the nut is correctly tightened, the tab 16 positioned facing the notch of the threaded stem returns to the non-deformed state and is received in the notch so as to prevent the nut from rotating relative to the threaded stem.

According to a second embodiment, shown in FIG. 2, a locking system 10, which is as one with the nut, takes the form of a washer 22 having multiple flaps 24 on its inner peripheral edge. In an initial state, the flaps 24 and the washer 22 are coplanar. Each flap 24 comprises a first part 24.1, connected to the washer 22 by a first bending line 26 approximately perpendicular to a radial direction, and a second part 24.2 that is separated from the washer 22 by a cut 28 positioned in the extension of the first bending line 26 and is connected to the first part 24.1 by a second bending line 30 perpendicular to the first bending line 26. The second part 24.2 forms a tab that is configured to occupy a non-deformed state, in which the first and second parts 24.1 and 24.2 are approximately coplanar, and a deformed state, in which the bent second part 24.2 is received in one of the notches of the threaded stem and prevents the nut from rotating in the loosening direction. In order to be able to position the washer 22 around a threaded stem, all of the flaps 24 are pivoted about the first bending line 26 in order that each of them is positioned in a plane perpendicular to the washer 22. According to this second embodiment, when the nut is correctly tightened, the second part 24.2, positioned facing the notch of the threaded stem, is deformed so as to prevent the nut from rotating relative to the threaded stem.

Whichever embodiment is used, there is a peripheral space between the cylindrical body 12 (or the washer 22) and the threaded stem.

U.S. Pat. No. 6,010,289 also proposes an unlocking tool 32, shown in FIG. 3, comprising a pin 34 in which there is positioned a washer 36 that supports a plurality of longitudinal fingers 38. The washer 36 and the longitudinal fingers 38 are configured such that the longitudinal fingers 38 can be positioned in the peripheral space between the cylindrical body 12 (or the washer 22) and the threaded stem. Thus, when the tool is pivoted, the longitudinal fingers 38 act on the deformed tab received in the notch of the threaded stem such that it no longer engages with the notch. This makes it possible to loosen the nut.

These embodiments are not entirely satisfactory since they require the provision of a peripheral space between the cylindrical body 12 (or the washer 22) and the threaded stem in order to be able to use the unlocking tool. This peripheral space means that the tabs must be longer, which generally makes them weaker.

The present invention seeks to remedy all or some of the drawbacks of the prior art.

### SUMMARY OF THE INVENTION

To that end, the invention relates to an unlocking tool configured for unlocking a bolt locking system comprising a threaded stem having a lateral surface and at least one longitudinal channel which extends from a first end of the threaded stem, a nut configured to be screwed onto the threaded stem, and a locking system which is as one with the nut and comprises at least one tab configured to occupy a non-deformed state, in which the tab does not prevent the nut from rotating with respect to the threaded stem, and a deformed state, in which the tab is partially received in the longitudinal channel and prevents the nut from rotating with respect to the threaded stem.

According to the invention, the unlocking tool comprises a ring that is configured to be positioned around the threaded stem in operation, and at least one finger extending between a first end connected to the ring and a second, free end, this finger being configured to be received and slide in the longitudinal channel of the threaded stem in operation, each finger comprising a front face delimited by a first edge and a second edge located downstream of the first edge in a direction of unscrewing of the nut, the front face of each finger having a first slope such that the first edge is set back from or level with the lateral surface of the threaded stem and such that the second edge stands proud of or is level with the lateral surface of the threaded stem.

According to the invention, the space between the lateral surface of the threaded stem and the tubular part supporting the tab or tabs can be reduced to a minimum provided that the unlocking tool comprises no element that is received in this space.

According to another feature, the second edge is set back from the lateral surface of the threaded stem.

According to one embodiment, the second edge and the lateral surface of the threaded stem are separated by a first distance of the order of (approximately) 0.5 mm.

According to another feature, the first edge stands proud of the lateral surface of the threaded stem.

According to one embodiment, the first edge and the lateral surface of the threaded stem are separated by a second distance of the order of (approximately) 0.5 mm.

According to another feature, the front face of each finger comprises a second slope such that each finger has a first thickness at the first end of the finger that is greater than a second thickness at the second, free end of the finger.

According to one embodiment, the first and second thicknesses have a difference in thickness of the order of (approximately) 0.5 mm.

According to another feature, each finger has first and second lateral faces that are separated by a distance approximately equal to that separating the first and second lateral walls of a longitudinal channel.

According to another feature, the unlocking tool is configured for a threaded stem having two diametrically opposite longitudinal channels and comprises two fingers, one for each longitudinal channel, the fingers being arranged such that, in operation, their rear faces slide against bottom walls of the two longitudinal channels.

According to another feature, at least each finger of the unlocking tool is made of or covered with a material having a low coefficient of friction with the longitudinal channel of the threaded stem.

### BRIEF DESCRIPTION OF THE DRAWINGS

Other features and advantages will emerge from the following description of the invention, which description is given solely by way of example, with reference to the appended drawings in which:

FIG. 1 is a perspective view of a locking system which illustrates a first embodiment of the prior art,

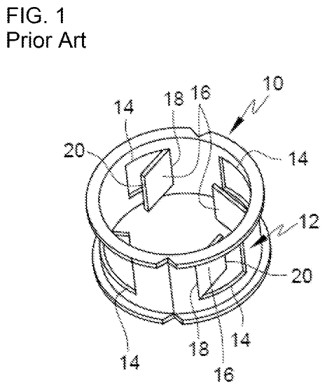

FIG. 2 is a top view of a locking system which illustrates a second embodiment of the prior art,

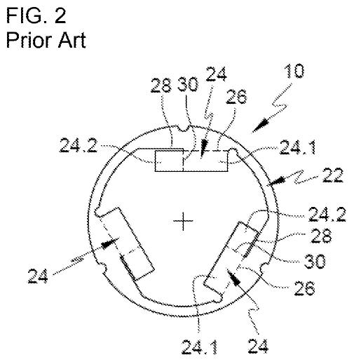

FIG. 3 is a longitudinal section of an unlocking tool which illustrates an embodiment of the prior art,

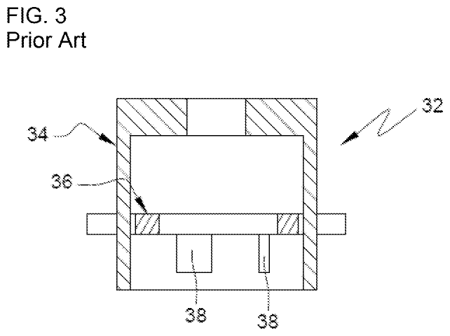

FIG. 4 is a perspective view of a screw which illustrates one embodiment of the invention,

FIG. 5 is a perspective view of a nut equipped with a locking system which illustrates one embodiment of the invention,

FIG. 6 is a developed lateral view of a nut equipped with a locking system which illustrates one embodiment of the invention,

FIG. 7 is a section of a nut equipped with a locking system which illustrates one embodiment of the invention,

FIG. 8 is a developed top view of a bolt equipped with a locking system in the activated state, which illustrates one embodiment of the invention,

FIG. 9 is a perspective view, from a first viewpoint, of an unlocking tool which illustrates one embodiment of the invention,

FIG. 10 is a perspective view, from a second viewpoint, of an unlocking tool which illustrates one embodiment of the invention,

FIG. 11 is a top view of the unlocking tool shown in FIG. 9,

FIG. 12 is a cross section through an unlocking tool positioned in a longitudinal channel of a screw, which illustrates one embodiment of the invention,

FIG. 13 is a longitudinal section through part of an unlocking tool positioned in a longitudinal channel of a screw, which illustrates one embodiment of the invention,

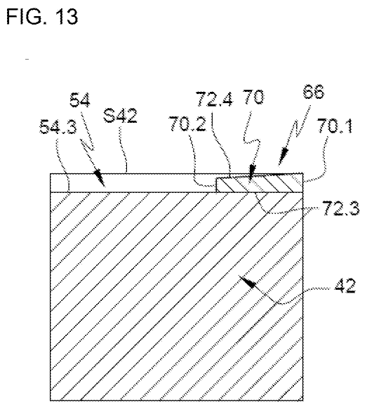

FIG. 14 is a detail cross section through an unlocking tool positioned in a longitudinal channel of a screw, which illustrates one embodiment of the invention, and

FIG. 15 is a detail cross section through an unlocking tool positioned in a longitudinal channel of a screw, which illustrates one embodiment of the invention.

### DETAILED DESCRIPTION OF THE PREFERRED EMBODIMENTS

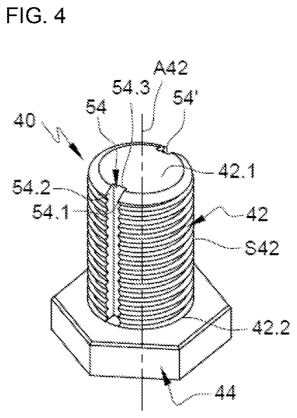

According to one embodiment, shown in FIG. 4, a screw 40 comprises a threaded stem 42 having an axis A42 and a lateral surface S42, the threaded stem 42 extending between a first end 42.1 and a second end 42.2. The screw 40 also comprises a system for immobilizing it and/or turning it, for example a hexagonal head 44, which is as one with the second end 42.2 of the threaded stem 42.

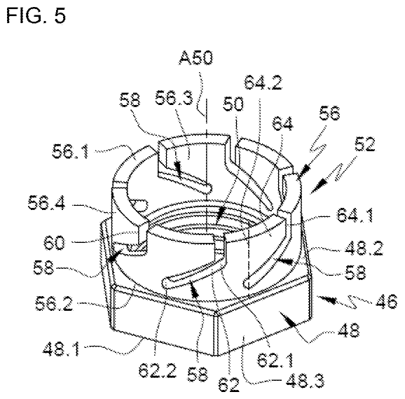

In FIG. 5, a nut 46 comprises a body 48 and a tapped hole 50, configured to be screwed onto the threaded stem 42 of the screw 40, that passes through the body 48 and has an axis A50 which coincides with the axis A42 of the threaded stem 42 when the nut 46 is screwed onto the screw 40.

The assembly comprising the threaded stem 42 and the nut 46 forms a bolt.

In the remainder of the description, a longitudinal direction is parallel to the axis A42 of the threaded stem 42, or to the axis A50 of the tapped hole 50 of the nut 46, a radial direction is perpendicular to the axis A42 of the threaded stem 42 or to the axis A50 of the tapped hole 50 of the nut 46, a longitudinal plane passes through the axis A42 of the threaded stem 42 or through the axis A50 of the tapped hole 50 of the nut 46, and a transverse plane is a plane perpendicular to the axis A42 of the threaded stem 42 or to the axis A50 of the tapped hole 50 of the nut 46.

The body 48 of the nut 46 comprises a first transverse face 48.1, a second transverse face 48.2 and a peripheral face 48.3 connecting the first and second transverse faces 48.1, 48.2, with the tapped hole 50 opening onto the first and second transverse faces 48.1, 48.2. According to one orientation, the threaded stem 42 is introduced into the tapped hole 50 of the nut 46 via the first transverse face 48.1. The body 48 of the nut 46 comprises a system for immobilizing it and/or turning it, for example a hexagonal section on the peripheral face 48.3, as shown in FIG. 5.

The nut 46 comprises a locking system 52 that is configured to prevent the nut 46 from rotating relative to the threaded stem 42.

According to one feature of the invention, the threaded stem 42 comprises at least one longitudinal channel 54 which extends from the first end 42.1 over at least part of the length of the threaded stem 42 (dimension considered in the longitudinal direction). According to one configuration, shown in FIG. 4, each longitudinal channel 54 extends from the first end 42.1 to the second end 42.2.

According to one embodiment, each longitudinal channel 54 comprises a first lateral wall 54.1, a second lateral wall 54.2 parallel to the first lateral wall 54.1, and a bottom wall 54.3 perpendicular to the first and second lateral walls 54.1, 54.2. To give an idea of scale, for a threaded stem 42 having a diameter of the order of 20 mm, the width of the longitudinal channel 54 (distance between the first and second lateral walls 54.1 and 54.2) is of the order of 3 mm. The depth of the longitudinal channel 54 (dimension between the bottom wall 54.3 of the longitudinal channel 54 and the lateral wall S42 of the threaded stem 42) is of the order of 2 mm.

According to one embodiment, shown in FIG. 4, the threaded stem 42 comprises two diametrically opposite longitudinal channels 54, 54′.

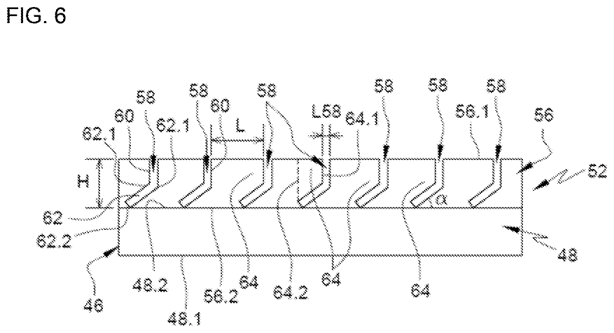

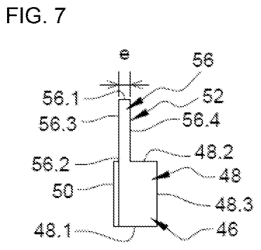

In addition to the longitudinal channel(s) 54, 54′, the locking system 52, as shown in FIG. 5, comprises a tubular part 56 that is as one with the nut 46 and coaxial with the tapped hole 50 and extends between a first end 56.1 and a second end 56.2 which is connected to the second transverse face 48.2 of the body 48 of the nut 46. This tubular part 56 comprises an internal face 56.3, the internal diameter of which is slightly greater than that of the tapped hole 50 (or essentially equal to that of the threaded stem 42), and an external face 56.4 that is coaxial with the internal face 56.3. According to one embodiment, for a threaded stem of the order of 20 mm, the tubular part 56 has a thickness e (distance between the internal and external faces 56.3, 56.4 shown in FIG. 7) of the order of 1.5 mm and a height H (distance between the first and second ends 56.1, 56.2 shown in FIG. 6) of the order of 7 mm.

The tubular part 56 comprises a plurality of slots 58 which are regularly distributed over the periphery of the tubular part 56 and connect the internal and external faces 56.3, 56.4.

According to one embodiment, each slot 58 opens at the first end 56.1 of the tubular part 56 and extends over at least part of the height of the tubular portion 56 (dimension considered between the first and second ends 56.1, 56.2).

According to one configuration, each slot 58 extends from the first end 56.1 to the second end 56.2.

According to one embodiment, each slot 58 comprises a first segment 60, oriented in the longitudinal direction and opening at the first end 56.1 of the tubular portion 56, and a second, inclined segment 62 extending between a first end 62.1 connected to the first segment 60 and a second end 62.2. According to one embodiment, shown in FIG. 6, the first segment 60 extends over the first, upper half of the tubular portion 56 and the second segment 62 extends over the second, lower half of the tubular portion 56. According to one embodiment, for a threaded rod having a diameter of the order of 20 mm, each slot 58 has a width L58 of the order of 1 mm and two consecutive slots 58 are separated by a distance L of the order of 9 mm at the level of the first end 56.1 of the tubular part 56. The second portion 62 forms an angle α of the order of 30° with a transverse plane. The inclined and vertical orientations of the slots 58 favor tightening.

Of course, the invention is not restricted to this embodiment for the slots 58.

Two consecutive slots 58 delimit a tab 64. According to one configuration, the tubular part 56 comprises seven slots 58 and seven tabs 64.

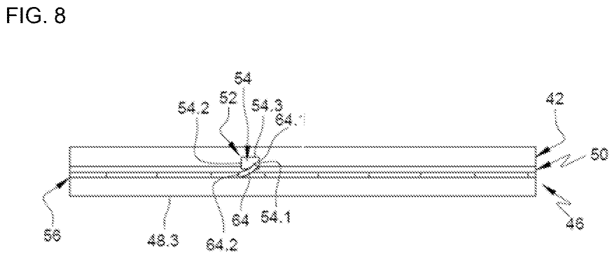

Each tab 64 is configured to occupy a non-deformed state in which the tab 64 does not project inside the tubular part 56, and a deformed state in which the tab 64 projects at least partially inside the tubular part 56, as shown in FIG. 8.

Each tab 64 comprises a free edge 64.1 and a bending line 64.2 which allows it to pivot between the non-deformed and deformed states. According to the embodiment shown in FIG. 6, the bending line 64.2 extends from the second end 62.2 of the second segment 62 to the first end 56.1 of the tubular part 56, along a direction approximately parallel to the longitudinal direction.

When the nut 46 is screwed onto the threaded stem 42, at least part of the tab 64 is received, in the deformed state, in one of the longitudinal channels 54, 54′ of the threaded stem 42. In this deformed state, the free edge 64.1 of the tab 64 is in abutment against the first lateral wall 54.1 of one of the longitudinal channels 54, 54′.

Of course, the invention is not limited to the embodiment illustrated in FIGS. 5 to 8 for the locking system 52. Thus, the latter could be identical to one of those described in U.S. Pat. No. 6,010,289.

Whatever the embodiment, the annular space between the tubular part 56 and the threaded stem 42 can be reduced or even eliminated.

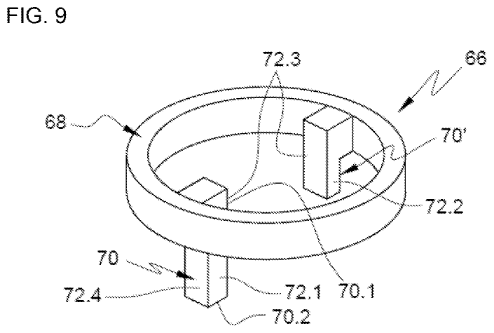

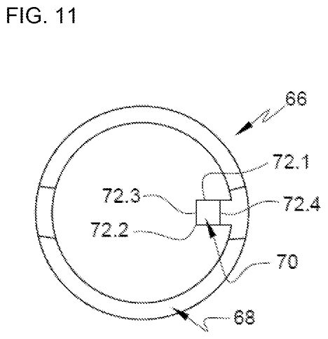

An unlocking tool 66 for a bolt locking system 56 is shown in FIGS. 9 to 11.

According to one embodiment, the unlocking tool 66 comprises a ring 68 that is configured to be positioned around the threaded stem 42 during operation, and at least one finger 70 that is configured to be received and slide in a longitudinal channel 54 of the threaded stem 42. Each finger 70 extends between a first end 70.1 connected to the ring 68 and a second, free end 70.2.

According to one configuration, the ring 68 has a square or rectangular cross section and has an internal diameter slightly greater than the diameter of the threaded stem 42 (or essentially equal to the internal diameter of the tubular part 56 of the nut 46) and an external diameter that is essentially equal to the external diameter of the tubular part 56 of the nut 46.

Each finger 70 is oriented in a direction essentially perpendicular to the plane of the ring 68. In operation, the ring 68 is positioned in a transverse plane and each finger 70 is oriented in the longitudinal direction.

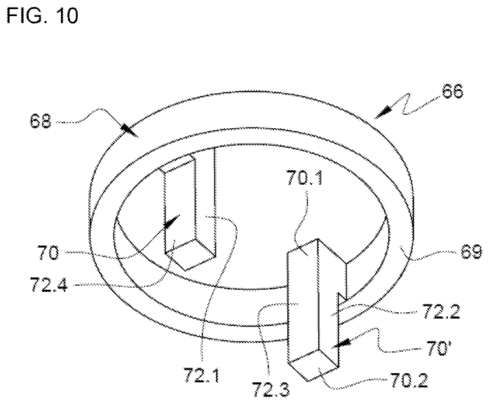

According to one configuration, shown in FIGS. 9 and 10, the unlocking tool 66 comprises two fingers 70, 70′, one for each longitudinal channel 54, 54′. The number and arrangement of the fingers 70, 70′ are determined in dependence on the number and arrangement of the longitudinal channels 54, 54′.

According to one configuration, all of the longitudinal channels 54, 54′ have the same cross section. All of the fingers 70, 70′ are essentially identical.

Each finger 70 has a first lateral face 72.1, a second lateral face 72.2 that is essentially parallel to the first lateral face 72.1, a rear face 72.3 that is essentially perpendicular to the first and second lateral faces 72.1, 72.2, and a front face 72.4 that is opposite the rear face 72.3 and is configured to engage with the tab or tabs.

The first and second lateral faces 72.1 and 72.2 are separated by a distance approximately equal to that between the first and second lateral walls 54.1, 54.2 of a longitudinal channel 54. The rear face 72.3 is configured to slide against the bottom wall 54.3 of the longitudinal channel 54 in operation. When the unlocking tool 66 comprises two fingers 70, 70′, these are configured such that, in operation, their rear faces 72.3 slide against the bottom walls 54.3 of the longitudinal channels 54, 54′. Thus, the distance between the rear faces 72.3 of the two fingers 70, 70′ is approximately equal to that between the bottom walls 54.3 of the two longitudinal channels 54, 54′. Each finger 70, 70′ has a length (dimension considered in the longitudinal direction) equal to the height of the tubular part 56.

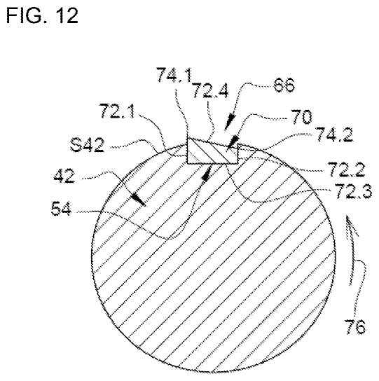

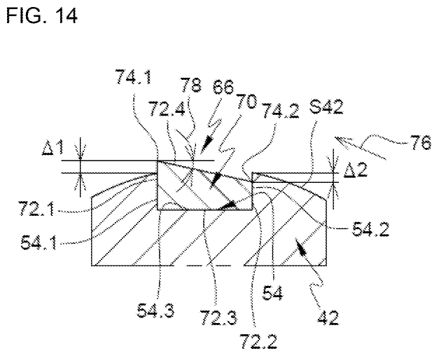

The front face 72.4 is delimited by a first edge 74.1 at the first lateral face 72.1 and a second edge 74.2 at the second lateral face 72.2, the second edge 74.2 being located downstream of the first edge 74.1 in the loosening direction indicated by the arrow 76 in FIGS. 12 and 14.

According to one feature, the front face 72.4 of each finger 70, 70′ comprises a first slope 78 such that the first edge 74.1 stands proud of or is level with the lateral surface S42 of the threaded stem 42 and such that the second edge 74.2 is set back from or level with the lateral surface S42 of the threaded stem 42 in order to avoid the tab 64 being wedged in one of the longitudinal channels 54, 54′ during loosening of the nut 46. Thus, the first face 72.1 has a width greater than or equal to the depth of each longitudinal channel 54, 54′, and the second lateral face 72.2 has a width less than or equal to the depth of the longitudinal channels 54, 54′. According to one configuration, the second edge 74.2 is set back from the lateral surface S42 of the threaded stem 42 in order to avoid the tab 64 being wedged in one of the longitudinal channels 54, 54′ during loosening of the nut 46. According to one configuration, the first edge 74.1 stands proud of the lateral surface S42 of the threaded stem 42 so as to facilitate the insertion of the finger 70, 70′ between the deformed tab 64 and the bottom wall 54.3 of the longitudinal channel 54, 54′.

According to one embodiment, shown in FIG. 14, the first edge 74.1 and the lateral surface S42 of the threaded stem 42 are separated by a first distance 41 of the order of (approximately) 0.5 mm (+/−1 mm) The second edge 74.2 and the lateral surface S42 of the threaded stem 42 are separated by a second distance 42 of the order of (approximately) 0.5 mm (+/−1 mm) These values are provided by way of example for a threaded stem of the order of 20 mm Whatever the value for the diameter of the threaded stem 42, the first and second distances 41 and 42 are essentially equal.

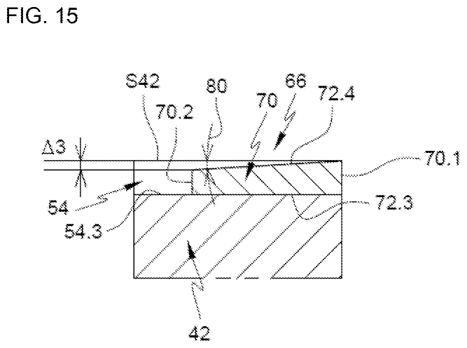

According to another feature, shown in FIG. 15, the front face 72.4 of each finger 70 comprises a second slope 80 such that each finger has a first thickness (distance between the rear and front faces 72.3, 72.4) at the first end 70.1 that is greater than a second thickness (distance between the rear and front faces 72.3, 72.4) at the second, free end 70.2. According to one configuration, in a median longitudinal plane (equidistant between the first and second lateral faces 72.1, 72.2), the front face 72.4 is positioned in the continuation of the lateral face S42 of the threaded stem 42 at the first end 70.1 of the finger 70, and the front face 72.4 is positioned set back from the lateral face S42 of the threaded stem 42 (offset inwardly towards the bottom wall 54.3 of the longitudinal channel 54) at the second end 70.2 of the finger 70. Thus, the second end 70.2 has a thickness (dimension considered in a radial direction) that is smaller than that of the first end 70.1. This configuration favors the insertion of the finger 70, 70′ between the deformed tab 64 and the bottom wall 54.3 of the longitudinal channel 54, 54′. According to one embodiment, the difference in thickness Δ3 between the first and second ends 70.1, 70.2 is of the order of (approximately) 0.5 mm (+/−1 mm) This value is provided by way of example for a threaded stem of the order of 20 mm Whatever the value for the diameter of the threaded stem 42, the difference in thickness Δ3 between the first and second ends 70.1, 70.2 and the first and second distances Δ1 and Δ2, between the first and second edge 74.1, 74.2 and the lateral surface S42 of the threaded stem 42, are essentially equal.

According to one mode of use, the unlocking tool 66 is secured to a ratchet key by any appropriate means, for example using a connection of the magnetic type.

According to one embodiment, at least each finger of the unlocking tool 66 is made of or covered with a material having a low coefficient of friction with the longitudinal channel 54, 54′ of the threaded stem 42, for example polytetrafluoroethylene, copper or a self-lubricating material.

The mode of operation of the unlocking tool 66 is as follows:

Each finger 70, 70′ is inserted into a longitudinal channel 54, 54′ and the ring 68 of the unlocking tool 66 is positioned around the threaded stem 42. The unlocking tool 66 is then moved in translation from the first end 42.1 of the threaded stem 42 towards the nut 46 such that at least one of the fingers 70, 70′ is interposed between the deformed tab 64 and the bottom wall 54.3 of the longitudinal channel 54 in which the deformed tab 64 is received. The unlocking tool 66 is then moved in translation until the lower surface 69 of the ring 68 is in contact with the first end 56.1 of the tubular part 56 of the nut 46.

If this insertion is difficult owing to the deformed tab 64 being wedged in the longitudinal channel 54, the nut 46 can be tightened slightly.

Once the finger 70 is interposed between the deformed tab 64 and the bottom wall 54.3 of the longitudinal channel 54, the nut 46 can be loosened without any of the tabs 64 becoming wedged in one of the longitudinal channels 54, 54′. During the operation of unscrewing the nut 46, the unlocking tool 66 moves in translation towards the first end 42.1 of the threaded stem 42 in the same way as the nut 46.

The unlocking tool according to the invention comprises no element configured to be received between the lateral surface S42 of the threaded stem 42 and the tubular part 56. Thus, the space between the lateral surface S42 of the threaded stem 42 and the tubular part 56 can be reduced to a minimum.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An unlocking tool configured for unlocking a bolt locking system comprising:
a threaded stem having a lateral surface and at least one longitudinal channel which extends from a first end of the threaded stem,
a nut configured to be screwed onto the threaded stem, and
a locking system which is as one with the nut and comprises at least one tab configured to occupy a non-deformed state, in which said tab does not prevent the nut from rotating with respect to the threaded stem, and a deformed state, in which said tab is partially received in the at least one longitudinal channel and prevents the nut from rotating with respect to the threaded stem,
wherein the unlocking tool comprises:
a ring that is configured to be positioned around the threaded stem in operation, and
at least one finger extending between a first end connected to the ring and a second, free end, this finger being configured to be received and slide in the at least one longitudinal channel of the threaded stem in operation,
the at least one finger comprising a front face delimited by a first edge and a second edge located downstream of the first edge in a direction of unscrewing of the nut,
the front face of the at least one finger having a first slope such that the first edge is set back from or level with the lateral surface of the threaded stem and such that the second edge stands proud of or is level with the lateral surface of the threaded stem.

2. The unlocking tool according to claim 1, wherein the second edge is set back from the lateral surface of the threaded stem.

3. The unlocking tool according to claim 2, wherein the second edge and the lateral surface of the threaded stem are separated by a first distance of approximately 0.5 mm.

4. The unlocking tool according to claim 1, wherein the first edge stands proud of the lateral surface of the threaded stem.

5. The unlocking tool according to claim 4, wherein the first edge and the lateral surface of the threaded stem are separated by a second distance of approximately 0.5 mm.

6. The unlocking tool according to one claim 1, wherein the front face of each finger comprises a second slope such that each finger has a first thickness at a first end of the finger that is greater than a second thickness at a second, free end of the finger.

7. The unlocking tool according to claim 6, wherein the first and second thicknesses have a difference in thickness of approximately 0.5 mm.

8. The unlocking tool according to claim 1, wherein each finger has first and second lateral faces that are separated by a distance approximately equal to that separating first and second lateral walls of a longitudinal channel.

9. The unlocking tool according to claim 1, said unlocking tool being configured for the threaded stem having two diametrically opposite longitudinal channels, wherein the unlocking tool comprises two fingers, one for each longitudinal channel, the fingers being arranged such that, in operation, their rear faces slide against bottom walls of the two longitudinal channels.

10. The unlocking tool according to claim 1, wherein at least each finger of the unlocking tool is made of or covered with a material having a low coefficient of friction with the longitudinal channel of the threaded stem.
